(19) United States
(12) Patent Application Publication
(10) Pub. No.: US 2007/0030849 A1
(43) Pub. Date: Feb. 8, 2007

(54) Voice over internet protocol (VoIP) terminal and information management method thereof

(76) Inventor: Myung-Joon Shin, Suwon-si (KR)

Correspondence Address: Robert E. Bushnell, Suite 300, 1522 K Street, N.W., Washington, DC, 20005-1202, US

(21) Appl. No.: 11/496,485

(22) Filed: Aug. 1, 2006

(30) Foreign Application Priority Data
Aug. 4, 2005 (KR) 10-2005-0071479

(51) Int. Cl. H04L 12/56

(52) U.S. Cl. 370/390; 370/400

(57) ABSTRACT

A Voice over Internet Protocol (VoIP) terminal and an information management method thereof, in which when any terminal requests receiving terminal information from any receiving terminal in order to communicate with the receiving terminal, a request message for receiving terminal information is transmitted to at least one terminal of a multicast group to which the receiving terminal belongs, and communication is conducted based upon the receiving terminal information received from the terminal of the multicast group. As a result thereof, when the telephone number of the receiving terminal is not known to a user or stored, the user can obtain the telephone number of the receiving terminal without having to inquire of a server or call center that has stored the telephone number of the receiving terminal.

### CLAIM OF PRIORITY

This application makes reference to and claims all benefits accruing under 35 U.S.C. §119 from an application for VOICE OVER INTERNET PROTOCOL TERMINAL AND METHOD FOR MANAGING INFORMATION THEREOF earlier filed in the Korean Intellectual Property Office on 4 Aug. 2005 and there duly assigned Serial No. 10-2005-0071479.

### BACKGROUND OF THE INVENTION

1. Field of the Invention

The present invention relates to a Voice over Internet Protocol (VoIP) terminal and an information management method thereof.

2. Description of the Related Art

VoIP is an Internet telecommunication technology in use for devices that transfer voice information via the Internet Protocol (IP). Unlike other protocols using lines such as Public Switched Telephone Network (PSTN), VoIP is used to transfer digitalized voice information in discontinuous packets.

Such a VoIP network is designed to provide voice call services by using the existing IP network as is so that VoIP subscribers can be supported with long distance and international call services in Internet and intranet environments by merely paying a local call rate.

A VoIP network has to conduct signaling for purpose of call connection and disconnection of terminals.

Examples of the signaling protocol used by such a VoIP network include H.323, Session Initiation Protocol (SIP), Media Gateway Control Protocol (MGCP) and so on.

Up to the present, the development of VoIP service techniques on the VoIP network has been focused on H.323.

However, currently, VoIP service technologies are being developed in conjunction with SIP, which is easily expandible and easily realizable owing to its text-based properties.

The SIP is a type of text-based application layer protocol intended for creating, modifying and terminating sessions with one or more participants, by which sessions are set up and controlled between terminals and their users.

Such sessions can include, for example, multimedia conferences, telecommunications and Short Message Service (SMS) using the Internet.

The SIP was developed by the Multi-party Multimedia Session Control (MMUSIC) working group of the Internet Engineering Task Force (IETF), published on March, 1993, with its standard being defined in ‘Request For Comments (RFC) 3261.

The SIP is a protocol designed with a client-server architecture, in a request/response mode. A request message is composed of INVITE, ACK, BYE, CANCEL, REGISTER AND OPTION methods, and a response message is composed of status codes including 1xx, 2xx, 3xx, 4xx, 5xx and 6xx.

A SIP-based VoIP network can consist of at least one user agent (hereinafter referred to as a “terminal”), an SIP server, a registrar server, a location server and so on.

The SIP server is consists of a proxy server and a redirect server.

When a redirect server receives a call connection request message from a transmitting terminal, requesting call connection with a receiving terminal, it provides the transmitting terminal with server address to use for connection with the receiving terminal, such that the transmitting terminal can transmit a call connection request message by itself to a corresponding server.

That is, the redirect server responds to the request from the transmitting terminal, but does not forward the call connection request message.

When a proxy server receives a call connection request message from a transmitting terminal, requesting call connection with a receiving terminal, it inquires a location server for location information of the receiving terminal, and based upon the location information of the receiving terminal provided from the location server, transmits a call connection request message to the receiving terminal.

Then, upon receiving a response message to the call connection request message from the receiving terminal, the proxy server transmits a corresponding response message to the transmitting terminal. Through these processes, a call is established between the transmitting and receiving terminals.

On the other hand, in response to location registration request from the terminal, the registrar server maps current location information or an IP address of the terminal with the telephone number of the terminal and stores the mapped information in the location server.

In the SIP based VoIP network, when a transmitting terminal user attempts to communicate with a receiving terminal user, he/she determines whether or not the telephone number of the receiving terminal is stored in the transmitting terminal.

When the transmitting terminal user does not know the telephone number of the receiving terminal or when the telephone number is not stored in the transmitting terminal, he/she has to inconveniently search for the telephone number in a server storing the telephone number or ask a call center to obtain the telephone number.

Unlike the location server, in response to a request from the transmitting terminal user for the telephone number of the receiving terminal, the server storing the telephone number of at least one terminal searches for the telephone number of the receiving terminal and provides the located telephone number to the transmitting terminal.

### SUMMARY OF THE INVENTION

An object of the present invention to provide a VoIP terminal and an information management method thereof which enables a user of a transmitting terminal, even when the user does not know the telephone number of a receiving terminal or the telephone number of the receiving terminal is not stored in the transmitting terminal, to find the telephone number of the receiving terminal without having to ask a server or a call center where the telephone number of the receiving terminal has been stored.

In order to realize the above objects, the present invention provides a Voice-over Internet Protocol (VoIP) terminal including: a controller adapted to transmit a request message for receiving terminal information to at least one terminal in a multicast group in response to a request for receiving terminal information from a receiving terminal with which the VoIP terminal is attempting to communicate and to communicate with the receiving terminal based on the receiving terminal information received from a certain terminal in the multicast group.

The receiving terminal information preferably includes at least one piece of information selected from a group consisting of a user name, telephone number and IP address of the receiving terminal.

The request message for receiving terminal information preferably includes at least one piece of information selected from a group consisting of a user name of the VoIP terminal, a telephone number of the VoIP terminal, an IP address of the VoIP terminal, a user name of the receiving terminal and a port number identifying an application necessary for communication between the VoIP terminal and the receiving terminal.

The receiving terminal information received from the certain terminal in the multicast group preferably includes at least one piece of information selected from a group consisting of a user name of the receiving terminal, a telephone number of the receiving terminal, an IP address of the receiving terminal and a port number identifying an application necessary for communication between the VoIP terminal and the receiving terminal.

The controller is preferably adapted to transmit the request message for receiving terminal information on a multicast packet to the at least one terminal in the multicast group.

The controller preferably includes: an information requesting portion adapted to generate a location registration message for VoIP communication, to transmit the location registration message to a server, to join the multicast group identified by a location registration complete message received from the server, and to transmit the request message for receiving terminal information to the at least one terminal in the multicast group at the request for receiving terminal information from the receiving terminal with which the VoIP terminal is attempting to communicate; a communicating portion adapted to communicate with the receiving terminal based on the receiving terminal information received from the certain terminal in the multicast group; and an updating portion adapted to update the terminal information of the certain terminal of the multicast group in response to the terminal information update request for VoIP communication from the certain terminal in the multicast group, and to transmit the changed VoIP terminal information to the at least one terminal in the multicast group upon VoIP terminal information being changed.

In order to realize the above objects, the present invention also provides a Voice-over Internet Protocol (VoIP) terminal including: an information requesting portion adapted to generate a location registration message for VoIP communication, to transmit the location registration message to a server, to join a multicast group identified by a location registration complete message received from the server, and to transmit a request message for receiving terminal information to at least one terminal in the multicast group in response to a request for receiving terminal information from a receiving terminal with which the VoIP terminal is attempting to communicate; and a communicating portion adapted to communicate with the receiving terminal based on the receiving terminal information received from a certain terminal in the multicast group.

The receiving terminal information preferably includes at least one piece of information selected from a group consisting of a user name, a telephone number and an IP address of the receiving terminal.

The request message for receiving terminal information preferably includes at least one piece of information selected from a group consisting of a user name of the VoIP terminal, a telephone number of the VoIP terminal, an IP address of the VoIP terminal, a user name of the receiving terminal and a port number identifying an application necessary for communication between the VoIP terminal and the receiving terminal.

The receiving terminal information received from the certain terminal in the multicast group preferably includes at least one piece of information selected from a group consisting of a user name of the receiving terminal, a telephone number of the receiving terminal, an IP address of the receiving terminal and a port number identifying an application necessary for communication between the VoIP terminal and the receiving terminal.

The information requesting portion is preferably adapted to transmit the request message for receiving terminal information on a multicast packet to the at least one terminal in the multicast group.

The VoIP terminal preferably further includes an updating portion adapted to update the terminal information of the certain terminal of the multicast group in response to the terminal information update request for VoIP communication from the certain terminal in the multicast group, and to transmit the changed VoIP terminal information to the at least one terminal in the multicast group in response to the VoIP terminal information being changed.

In order to realize the above objects, the present invention further provides a Voice-over Internet Protocol (VoIP) system including: a VoIP terminal and a server; the VoIP terminal being adapted to generate a location registration message for VoIP communication, to transmit the location registration message to the server, to join a multicast group identified by a location registration complete message received from the server, and to transmit a request message for receiving terminal information to at least one terminal in the multicast group in response to the request for receiving terminal information from a receiving terminal with which the VoIP terminal is attempting to communicate, and to communicate with the receiving terminal based on the receiving terminal information received from a certain terminal in the multicast group; and the server being adapted to register the location of the VoIP terminal based on VoIP terminal information included in the location registration message upon receiving the location registration message, to identify the multicast group of the VoIP terminal based on the VoIP terminal information, and to transmit multicast group information of the VoIP terminal on the location registration complete message to the VoIP terminal.

The VoIP terminal information included in the location registration message preferably includes a telephone number or an IP address of the VoIP terminal.

In order to realize the above objects, the present invention stil further provides an information management method of a Voice over Internet Protocol (VoIP) terminal, the method including: transmitting a request message for receiving terminal information to at least one terminal in a multicast group at a request for receiving terminal information of a receiving terminal with which the VoIP terminal is attempting to communicate; and communicating with the receiving terminal based on the receiving terminal information received from a certain terminal in the multicast group.

The receiving terminal information preferably includes at least one piece of information selected from a group consisting of a user name, a telephone number and an IP address of the receiving terminal.

The request message for receiving terminal information preferably includes at least one piece of information selected from a group consisting of a user name of the VoIP terminal, a telephone number of the VoIP terminal, an IP address of the VoIP terminal, a user name of the receiving terminal and a port number identifying an application necessary for communication between the VoIP terminal and the receiving terminal.

The receiving terminal information received from the certain terminal in the multicast group preferably includes at least one piece of information selected from a group consisting of a user name of the receiving terminal, a telephone number of the receiving terminal, an IP address of the receiving terminal and a port number identifying an application necessary for communication between the VoIP terminal and the receiving terminal.

The request message for receiving terminal information is preferably transmitted on a multicast packet to the at least one terminal in the multicast group.

The information management method preferably further includes: updating the terminal information of the certain terminal of the multicast group in response to a terminal information update request for VoIP communication from the certain terminal in the multicast group; and transmitting the changed VoIP terminal information to the at least one terminal in the multicast group upon information of the VoIP terminal being changed.

In order to realize the above objects, the present invention yet further provides a information management method of a Voice over Internet Protocol (VoIP) system including at least one terminal and a server, the method including: transmitting terminal information on a location registration message for VoIP communication to the server from a terminal; location-registering the terminal based upon the terminal information in the location registration message upon receiving the location registration message, identifying a multicast group of the terminal based upon the terminal information, and transmitting multicast group information of the terminal on a location-registration complete message to the terminal from the server; and joining the multicast group of the terminal included in the location-registration message received from the server at the terminal, and transmitting a request message for the receiving terminal information to at least one terminal of the multicast group from the terminal in response to a request for receiving terminal information from a receiving terminal with which the terminal is attempting to communicate.

The terminal information included in the location-registration message preferably includes at least one piece of information selected from a group consisting of a telephone number and an IP address of the terminal.

The information management method preferably further includes: updating the terminal information of the terminal belonging to the multicast group at the terminal in response to a request from a terminal belonging to the multicast group to update terminal information of the terminal of the multicast group for VoIP communication; transmitting the terminal information to the at least one terminal of the multicast group from the terminal upon the terminal information being changed; and requesting a call to the receiving terminal based upon the receiving terminal information from the terminal in response to a call request to the receiving terminal.

### BRIEF DESCRIPTION OF THE DRAWINGS

A more complete appreciation of the present invention and many of the attendant advantages thereof will be readily apparent as the present invention becomes better understood by reference to the following detailed description when considered in conjunction with the accompanying drawings in which like reference symbols indicate the same or similar components, wherein:

FIG. 1 is a conceptual diagram of a VoIP network to which the present invention is applied;

FIG. 2 is a block diagram of a terminal of FIG. 1;

FIG. 3 is a block diagram of a registrar server of FIG. 1;

FIG. 4 is a flowchart of an information management process for a terminal according to an embodiment of the present invention;

FIG. 5 is a flowchart of an information management process for a registrar server according to an embodiment of the present invention;

FIG. 6A is a view of request information for user information of a receiving terminal; and

FIG. 6B is a view of user information of a receiving terminal.

### DETAILED DESCRIPTION OF THE INVENTION

The following is a detailed description of a VoIP terminal and a management method thereof according to embodiments of the present invention with reference to the accompanying drawings, in which the same reference signs are used to designate the same or similar components throughout.

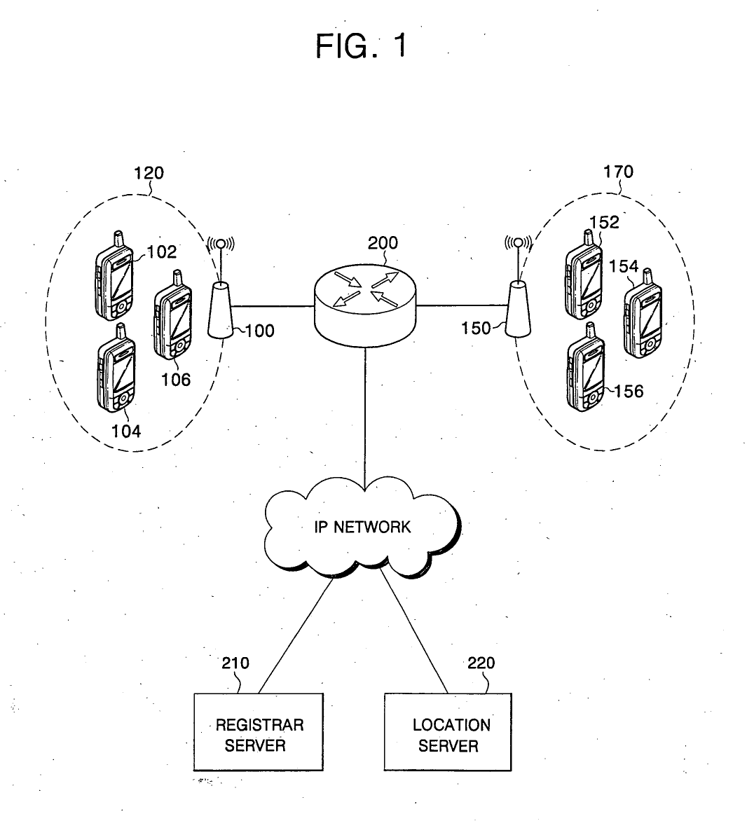

FIG. 1 is a conceptual diagram of a VoIP network to which the present invention is applied. As shown in FIG. 1, a VoIP network includes terminals 102, 104, 106, 152, 154 and 156, Access Points (Aps) 100 and 150, a router 200, a registrar server 210 and a location server 220.

An IP network is connected to the router 200, the registrar server 210, the location server 220 and so on. The APs 100 and 150 are connected to the IP network via the router 200.

The terminals 102, 104, 106, 152, 154 and 156 generate and transfer a REGISTER message to the registrar server 210, for the purpose of location registration during initialization.

The REGISTER message includes the IP address, telephone number and so on of the terminals.

The registrar server 210 stores address information of a multicast group where at least one of the terminals belongs. Upon receiving a REGISTER message from any of the terminals 102, 104, 106, 152, 154 and 156, the registrar server 210 stores the IP address and telephone number of the REGISTER message in the location server 220 by mapping them.

A network manager can divide the terminals 102, 104, 106, 152, 154 and 156 into multicast groups for specific purposes. That is, the terminals 102, 104 and 106 can be set to a multicast group A by the network manager, and the terminals 152, 154 and 156 can be set to a multicast group B by the network manager. The multicast group A can be a teleconference group, and the multicast group B can be a group that is made to listen to remote class.

While FIG. 1 shows that the terminals of the multicast group A are located within a service coverage 120 of the AP 100, the terminals of the multicast group A can be located within a service coverage 170 of the AP 150. In the same manner, the terminals of the multicast group B can also be located within the service coverage of the AP 100 even though they are shown as being located within the service coverage 120 of the AP 150.

When location registration of a terminal has been effected, the registrar server 210 transmits the multicast group address information of the terminal on a 200 OK message to the terminal which has requested the location registration. The multicast group address information is stored in the registrar server 210 or the location server 220.

One of the terminals 102, 104, 106, 152, 154, or 156 stores multicast group information of the 200 OK message received from the registrar server 210, and transmits multicast group information and its own IP address on a join message to the router 200 in order to join a multicast group the information of which has been received from the registrar server 210.

In case of withdrawing from the multicast group received from the registrar server 210, the one of the terminals 102, 104, 106, 152, 154, or 156 transmits the multicast group information and its own IP address on a leave message to the router 200.

The router 200 has a multicast group address item possessing at least one member, and generates or updates the multicast group address item according to Internet Group Management Protocol (IGMP) to manage a multicast routing table.

That is, the router 200, generates or updates the multicast group address by using IGMP; in response to the join message or leave message received from the one of the terminals 102, 104, 106, 152, 154, or 156, thereby managing the multicast routing table.

The multicast routing table includes address information of at least one multicast group and the IP address of at least one terminal belonging to the multicast group.

When the one of the terminals 102, 104, 106, 152, 154, or 156 receives a join response message informing its joining to the multicast group from the router 200, it transmits/receives a multicast packet or unitcast packet to/from at least one terminal belonging to the multicast group.

That is, when the one of the terminals 102, 104, 106, 152, 154, or 156 has joined the multicast group, if there is any change in its terminal user information for VoIP communication or any need for specific terminal user information for VoIP communication, the one of the terminals 102, 104, 106, 152, 154, or 156 transmits the changed terminal user information or a request for the specific terminal user information on a multicast packet to the router 200.

Terminal user information includes the user name, telephone number and IP address of a terminal, and etc. In a multicast packet transmitted from the one of the terminals 102, 104, 106, 152, 154, or 156 to the router 200, the destination address is multicast group address, and the source address is the IP address of the terminal that has transmitted the multicast packet. The terminal user information can be changed when the name of the terminal user has changed or when the telephone number of the terminal has changed.

If a multicast packet is received from the one of the terminals 102, 104, 106, 152, 154, or 156, the router 200 duplicates the multicast packet by the number of IP addresses of the terminals belonging to a multicast group corresponding to multicast group address of the multicast packet, and multicasts the duplicated packets to the terminals.

Upon receiving the multicast packet having terminal user information, the one of the terminals 102, 104, 106, 152, 154, or 156 determines whether or not corresponding terminal user information is stored in the multicast packet, and if the corresponding terminal user information is stored in the multicast packet, updates existing terminal user information with the changed terminal user information and displays the updated terminal user information.

If a multicast packet transmitted from a transmitting terminal includes a request for receiving terminal user information by the transmitting terminal, the one of the terminals 102, 104, 106, 152, 154, or 156 determines whether or not the receiving terminal user information requested by the transmitting terminal is stored in the multicast packet. If the receiving terminal user information requested by the transmitting terminal is stored in the multicast packet, then the one of the terminals 102, 104, 106, 152, 154, or 156 transmits the receiving terminal user information on a unicast packet to the transmitting terminal via the router 200.

The unicast packet having the receiving terminal user information requested by the transmitting terminal has source and destination addresses, in which the source address information is the IP address of the one of the terminals 102, 104, 106, 152, 154, or 156, and the destination address is the IP address of the transmitting terminal.

If the receiving terminal user information requested by the one of the terminals 102, 104, 106, 152, 154, or 156 is included in the unicast packet received from the router 200, then the one of the terminals 102, 104, 106, 152, 154, or 156 stores the receiving terminal user information and displays it to the user.

Then, if the user selects a receiving terminal to communicate with, the one of the terminals 102, 104, 106, 152, 154, or 156 transmits an INVITE message to the IP address of the receiving terminal included in the receiving terminal user information.

In response to the INVITE message from the one of the terminals 102, 104, 106, 152, 154, or 156, the receiving terminal transmits a 180 Ringing message to the one of the terminals 102, 104, 106, 152, 154, or 156.

Then, in response to a PRACK message received from the one of the terminals 102, 104, 106, 152, 154, or 156 within a predetermined time, the receiving terminal transmits a 200 OK message to the one of the terminals 102, 104, 106, 152, 154, or 156. The PRACK message is a message to indicate that the one of the terminals 102, 104, 106, 152, 154, or 156 has received the 180 Ringing message and to stop the receiving terminal from repeatedly retransmitting the 180 Ringing message.

The one of the terminals 102, 104, 106, 152, 154, or 156 generates and transmits an ACK message to the receiving terminal in response to the 200 OK message. This results in call establishment between the one of the terminals 102, 104, 106, 152, 154, or 156 and the receiving terminal. That is, through the call establishment, the user of the one of the terminals 102, 104, 106, 152, 154, or 156 can communicate with the user of the receiving terminal.

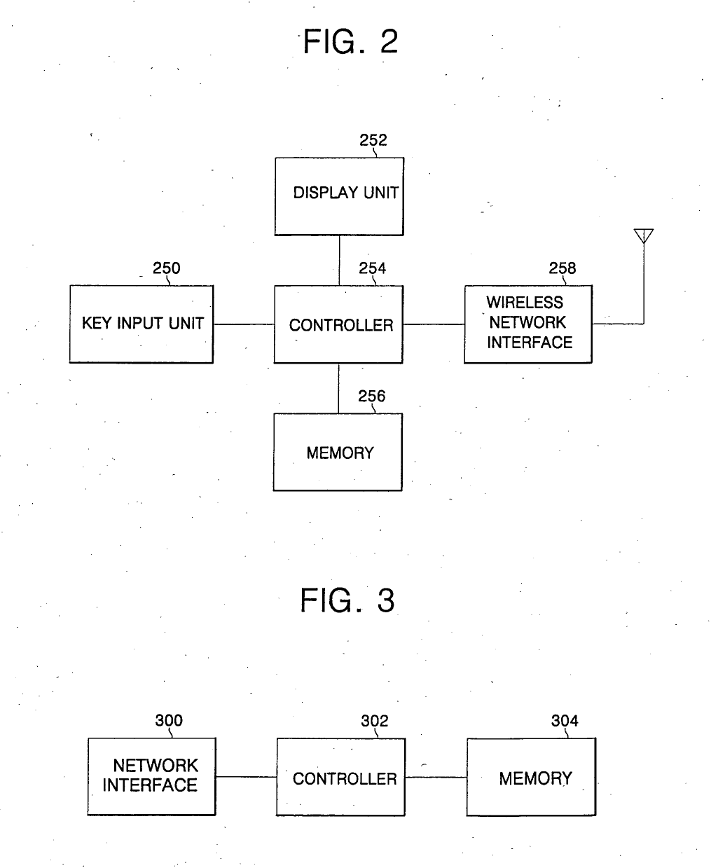

FIG. 2 is a block diagram of a terminal shown in FIG. 1. As shown in FIG. 2, a terminal in accordance with an embodiment of the present invention includes a key input unit 250, a display unit 252, a controller 254, a memory 256 and a wireless network interface 258.

The key input unit 250 has at least one key including a user information changing key and a talk key, and generates a key selection signal in response to key selection and then provides the key selection signal to the controller 254.

At initialization of the terminal, the controller 254 generates and transmits a REGISTER message to the registrar server 210 via the wireless network interface 258 for the purpose of location registration of the terminal.

Herein a wireless network interface is used since the terminal of FIG. 2 accesses the wireless network. Of course, a wired network interface will be used if the terminal of FIG. 2 accesses a wired network. In addition, the REGISTER message includes the IP address, telephone number and so on of the terminal.

As the 200 OK message is received from the registrar server 210 via the wireless network interface 258, the controller 254 stores multicast group address information of the 200 OK message in the memory 256.

When joining a multicast group corresponding to the multicast group address information received from the registrar server 210, the controller 254 transmits a join message to the router 200 via the wireless network interface 258, carrying the multicast group address information of the multicast group to which the controller 254 belongs and the IP address of the controller 254.

When leaving the multicast group corresponding to the multicast group address information received from the registrar server 210, the controller 254 transmits its multicast group address information and IP address on a leave message to the router 200 via the wireless network interface 258.

When a join response message indicating the joining to the multicast group has been received from the router 200, the controller 254 then transmits/receives a multicast or unicast packet to/from at least one terminal that belongs to the multicast group.

That is, the controller 254 joins the multicast group, and when receiving the key selection signal corresponding to a user information change key for changing the terminal user information for VoIP communication, requests the change of the terminal user information via the display unit 252.

If the terminal user information is changed via the key input unit 250, the controller transmits the changed terminal user information on the multicast packet to the router 200. Of course, the controller 254 can preferably store the changed terminal user information in the memory 256.

When there is a request for the receiving terminal user information for VoIP communication, the controller 254 determines whether or not the requested receiving terminal user information has been stored in the memory 256, and if the receiving terminal user information has been stored in the memory 256, displays the corresponding information via the display unit 252.

If the receiving terminal user information has not been stored in the memory 256, then the controller 254 transmits a request information for the receiving terminal user information on the multicast packet to the router 200.

Herein the terminal user information includes, for example, user name, telephone number and IP address of the terminal. The destination address included in the multicast packet to be transmitted to the router 200 is a multicast group address, and the source address included in the multicast packet is the IP address of a terminal which has transmitted the multicast packet. Changing the terminal user information can include changing the terminal user name or the terminal telephone number.

When a unicast packet including the receiving terminal user information is received from the router 200, the controller 254 stores the receiving terminal user information in the memory 256, and displays the receiving terminal user information via the display unit 252.

On the other hand, if the unicast packet including the receiving terminal user information is not received from the router 200, then the controller 254 transmits a request information for the receiving terminal user information on a unicast packet to the registrar server 210.

If a multicast packet transmitted from a transmitting terminal includes a request for receiving terminal user information of a receiving terminal with which the transmitting terminal attempts to conduct VoIP communication, then the controller 254 determines whether or not the receiving terminal user information requested by the transmitting terminal has been stored in the memory 256.

Then, if the receiving terminal user information requested by the transmitting terminal has been stored in the memory 256, the controller 254 transmits the receiving terminal user information on a unicast packet to the transmitting terminal.

The source address of the unicast packet including the receiving terminal user information requested by the transmitting terminal is the IP address of a terminal that includes the controller 254, and the destination address thereof is the IP address of the transmitting terminal.

At user selection of a receiving terminal to communicate with via the key input unit 250, if a key selection signal corresponding to a talk key has been inputted, then the controller 254 transmits an INVITE message via the wireless network interface 258 to the IP address of the receiving terminal included in corresponding receiving terminal user information.

When a 180 Ringing message has been received from the receiving terminal, the controller 254 transmits a PRACK message via the wireless network interface 258, and transmits an ACK message in response to the 200 OK message to the receiving terminal. This enables call establishment with the receiving terminal.

FIG. 3 is a block diagram of a registrar server of FIG. 1. As shown in FIG. 3, the registrar server includes a network interface 300, a controller 302 and a memory 304.

The memory 304 stores the IP address of one or more terminals corresponding to different multicast group address information.

When a REGISTER message for location registration has been received via the network interface 300 from one of the terminals 102, 104, 106, 152, 154 or 156, the controller 302 maps the telephone number with the IP address of the REGISTER message, and stores the mapped information in the location server 220.

Upon completion of the location registration of the terminal that requested location registration, the controller 302 acquires multicast group address information of the terminal based upon the IP address of the terminal, and transmits the acquired multicast group address information on a 200 OK message to the terminal.

In case of having received a unicast packet including request information for receiving terminal user information from one of the terminals 102, 104, 106, 152, 154 or 156, the controller 302 acquires corresponding receiving terminal user information from a location server, and transmits the receiving terminal user information on the unicast packet to the one of the terminals 102, 104, 106, 152, 154 or 156.

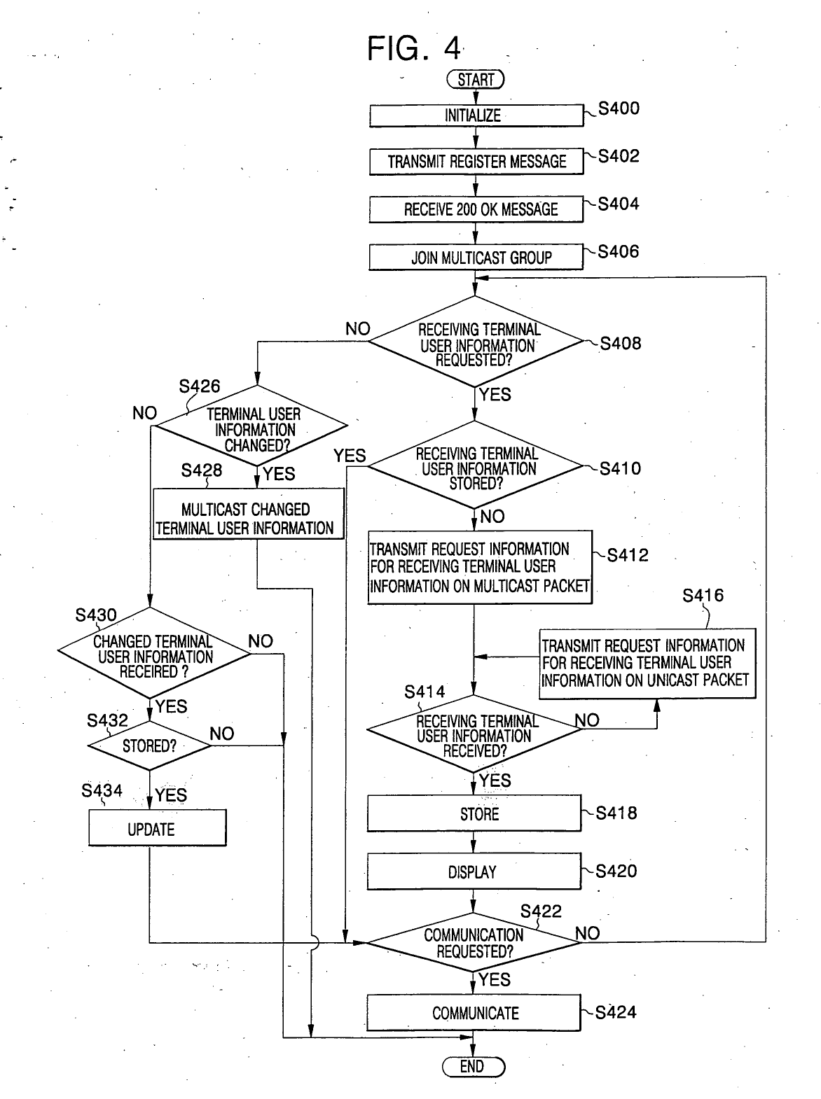

FIG. 4 is a flowchart of an information management process for a terminal according to an embodiment of the present invention. As shown in FIG. 4, when a terminal is initialized in S400, for the purpose of location registration, the terminal transmits a REGISTER message to a registrar server connected to the network in S402.

The REGISTER message includes, for example, the IP address and telephone number of the terminal.

Upon completion of location registration by the registrar server, the terminal stores multicast group address information of a 200 OK message received from the registrar server in a database in S404.

In S406, the terminal transmits the multicast group address information and its own IP address on a join message to the network in order to join a multicast group indicated by the registrar server.

When receiving a join response message from the network, indicating that the terminal has joined the multicast group, the terminal determines whether or not receiving terminal user information for VoIP communication has been requested in S408.

If there is a request for the receiving terminal user information for VoIP communication, the terminal determines whether or not the receiving terminal user information has been stored in the database in S410.

If the receiving terminal user information for VoIP communication has not been stored in the database, the terminal transmits a request information for the receiving terminal user information on a multicast packet to the network in S412. The destination address of the multicast packet transmitted to the network is the multicast group address of the terminal, and the source address thereof is the IP address of the terminal.

The request information for the receiving terminal user information includes at least one of the terminal user name, the terminal telephone number, the terminal IP address, the application port number for VoIP communication and the receiving terminal user name.

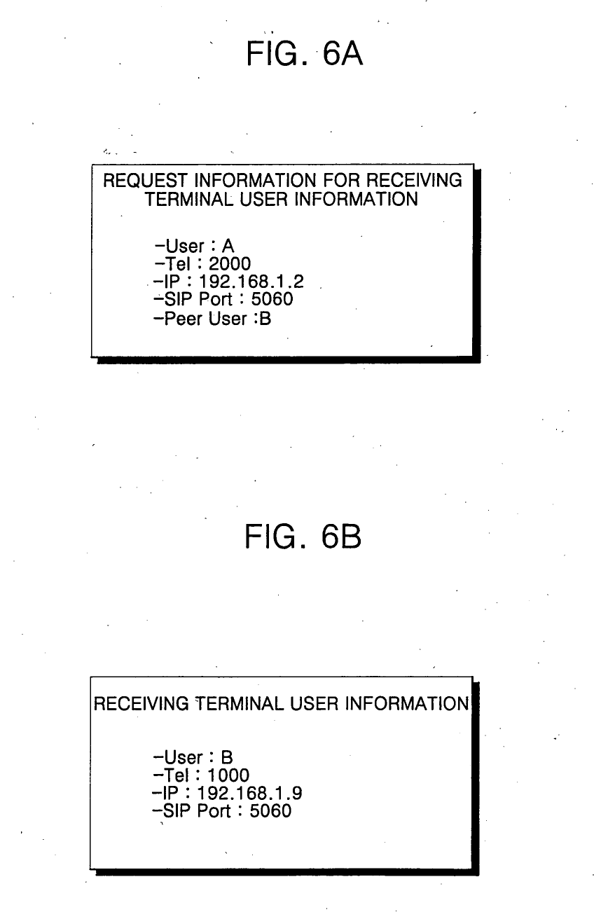

Such an example is illustrated in FIG. 6A. As shown in FIG. 6A, the request information for the receiving terminal user information includes the terminal user name A, the terminal telephone number 2000, the terminal IP address 192.168.1.2, the port number 5060 representing SIP as an application for VoIP communication and the receiving terminal user name B.

Then, in S414, the terminal determines whether or not a unicast packet including the receiving terminal user information has been received from the network.

If the receiving terminal information is included in the unicast packet received from the network, then the terminal stores the receiving terminal user information in the database in S418, and displays the receiving terminal user information by a display unit in S420.

The receiving terminal user information in the unicast packet received from the network includes at least one of the receiving terminal user name, the receiving terminal telephone number, the receiving terminal IP address and the application port number of VoIP communication.

Such an example is illustrated in FIG. 6B. As shown in FIG. 6B, the receiving terminal user information in the unicast packet received from the network includes thebreceiving terminal user name B, the receiving terminal telephone number 1000, the receiving terminal IP address 192.168.1.9 and the port number 5060 representing SIP as an application for VoIP communication.

Then, in S422, the terminal determines whether or not there is a communication request for any receiving terminal, and transmits an INVITE message to the receiving terminal with which the terminal attempts to communicate, by using the IP address of the receiving terminal included in the receiving terminal user information.

If a 180 Ringing message has received from the receiving terminal, then the terminal transmits a PRACK message to the receiving terminal, and in response to a 200 OK message received from the receiving terminal, transmits an ACK message to the receiving terminal. In this fashion, the terminal establishes a call with the receiving terminal to enable communication in S424.

If the unicast packet including the receiving terminal user information has not been received from the network in S414, then the terminal transmits a request information for the receiving terminal user information on a unicast packet to the registrar server in S416.

Herein, the destination address of the unicast packet transmitted to the registrar server is the IP address of the registrar server, and the source address thereof is the IP address of the terminal.

If the requested receiving terminal user information is determined to be stored in the database in S410, the terminal determines whether or not there is a conversation request for the receiving terminal in S422. The terminal transmits an INVITE message to the receiving terminal with which the terminal attempts to communicate, by using the IP address of the receiving terminal included in the receiving terminal user information.

When receiving a 180 Ringing message from the receiving terminal, the terminal transmits a PRACK message to the receiving terminal, and in response to a 200 OK message received from the receiving terminal, transmits an ACK message to the receiving terminal. In this fashion, the terminal establishes a call with the receiving terminal to enable communication in S424.

If it has been determined that the receiving terminal user information for VoIP communication has not been requested in S408, the terminal determines whether or not there is a request for change in its own terminal user information in S426.

If there is a request to change its own terminal user information, the terminal outputs a request via the display unit to input the terminal user information to be changed. After the terminal user information to be change has been is inputted, the terminal transmits the changed terminal user information on a multicast packet to the network in S428. Herein, the destination address of the multicast packet including the terminal user information is the multicast group address of the terminal, and the source address thereof is the IP address of the terminal.

On the other hand, if there is no request for change in its own terminal user information in S426, the terminal determines whether or not a multicast packet including changed transmitting terminal user information has been received from any transmitting terminal via the network in S430.

When the changed transmitting terminal user information has been received from a transmitting terminal via the network, the terminal determines whether or not corresponding transmitting terminal user information is stored in the database in S432. Herein, a determination as to whether or not transmitting terminal user information corresponding to the changed transmitting terminal user information is stored can be based upon the coincidence of transmitting terminal user name.

If any transmitting terminal user information stored in the database corresponds to the changed transmitting terminal user information, the terminal updates the transmitting terminal user information stored in the database with the changed transmitting terminal user information in S434.

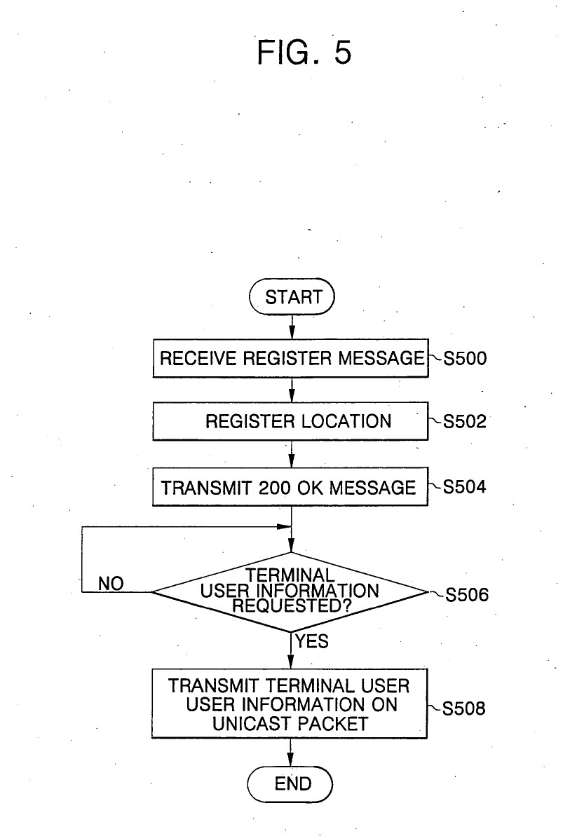

FIG. 5 is a flowchart of an information management process for a registrar server according to an embodiment of the present invention. As shown in FIG. 5, when a REGISTER message for location registration has been received from any terminal via the network in S500, the registrar server maps the IP address and telephone number included in the REGISTER message and stores the mapped information in a location server in order to register the location of the terminal in S502.

Then, if the terminal which has requested the location registration has been location-registered, the registrar server transmits a 200 OK message including the multicast group address information of the terminal to the network in S504. Herein, the multicast group address information can be stored in the registrar server or location server.

The registrar server determines whether or not a request message for any receiving terminal user information has been received from the network in S506. In this case, the request message for the receiving terminal user information from the network is preferably transmitted on a unicast packet.

If the request message for the receiving terminal user information has been received from the network, then the registrar server transmits the receiving terminal user information stored in the database on the unicast packet to the network in S508.

According to the VoIP terminal and the information management method thereof of the embodiment of the present invention described above, when any terminal requests receiving terminal information of any receiving terminal in order to communicate with the receiving terminal, a request message for the receiving terminal information is transmitted to at least one terminal of a multicast group to which the receiving terminal belongs, and communication is conducted based upon the receiving terminal information received from the terminal of the multicast group. As a result, when the telephone number of the receiving terminal is not known to a user or stored, the user can find the telephone number of the receiving terminal without having to inquire of a server or call center that stores the telephone number of the receiving terminal.

While the present invention has been shown and described in connection with the exemplary embodiments thereof, it will be apparent to those skilled in the art that modifications and variations can be made without departing from the spirit and scope of the present invention as defined by the appended claims.

What is claimed is:

1. A Voice-over Internet Protocol (VoIP) terminal comprising: a controller adapted to transmit a request message for receiving terminal information to at least one terminal in a multicast group in response to a request for receiving terminal information from a receiving terminal with which the VoIP terminal is attempting to communicate and to communicate with the receiving terminal based on the receiving terminal information received from a certain terminal in the multicast group.

2. The VoIP terminal according to claim 1, wherein the receiving terminal information includes at least one piece of information selected from a group consisting of a user name, telephone number and IP address of the receiving terminal.

3. The VoIP terminal according to claim 1, wherein the request message for receiving terminal information includes at least one piece of information selected from a group consisting of a user name of the VoIP terminal, a telephone number of the VoIP terminal, an IP address of the VoIP terminal, a user name of the receiving terminal and a port number identifying an application necessary for communication between the VoIP terminal and the receiving terminal.

4. The VoIP terminal according to claim 1, wherein the receiving terminal information received from the certain terminal in the multicast group includes at least one piece of information selected from a group consisting of a user name of the receiving terminal, a telephone number of the receiving terminal, an IP address of the receiving terminal and a port number identifying an application necessary for communication between the VoIP terminal and the receiving terminal.

5. The VoIP terminal according to claim 1, wherein the controller is adapted to transmit the request message for receiving terminal information on a multicast packet to the at least one terminal in the multicast group.

6. The VoIP terminal according to claim 1, wherein the controller comprises:
an information requesting portion adapted to generate a location registration message for VoIP communication, to transmit the location registration message to a server, to join the multicast group identified by a location registration complete message received from the server, and to transmit the request message for receiving terminal information to the at least one terminal in the multicast group at the request for receiving terminal information from the receiving terminal with which the VoIP terminal is attempting to communicate;
a communicating portion adapted to communicate with the receiving terminal based on the receiving terminal information received from the certain terminal in the multicast group; and
an updating portion adapted to update the terminal information of the certain terminal of the multicast group in response to the terminal information update request for VoIP communication from the certain terminal in the multicast group, and to transmit the changed VoIP terminal information to the at least one terminal in the multicast group upon VoIP terminal information being changed.

7. A Voice-over Internet Protocol (VoIP) terminal comprising:
an information requesting portion adapted to generate a location registration message for VoIP communication, to transmit the location registration message to a server, to join a multicast group identified by a location registration complete message received from the server, and to transmit a request message for receiving terminal information to at least one terminal in the multicast group in response to a request for receiving terminal information from a receiving terminal with which the VoIP terminal is attempting to communicate; and
a communicating portion adapted to communicate with the receiving terminal based on the receiving terminal information received from a certain terminal in the multicast group.

8. The VoIP terminal according to claim 7, wherein the receiving terminal information includes at least one piece of information selected from a group consisting of a user name, a telephone number and an IP address of the receiving terminal.

9. The VoIP terminal according to claim 7, wherein the request message for receiving terminal information includes at least one piece of information selected from a group consisting of a user name of the VoIP terminal, a telephone number of the VoIP terminal, an IP address of the VoIP terminal, a user name of the receiving terminal and a port number identifying an application necessary for communication between the VoIP terminal and the receiving terminal.

10. The VoIP terminal according to claim 7, wherein the receiving terminal information received from the certain terminal in the multicast group includes at least one piece of information selected from a group consisting of a user name of the receiving terminal, a telephone number of the receiving terminal, an IP address of the receiving terminal and a port number identifying an application necessary for communication between the VoIP terminal and the receiving terminal.

11. The VoIP terminal according to claim 7, wherein the information requesting portion is adapted to transmit the request message for receiving terminal information on a multicast packet to the at least one terminal in the multicast group.

12. The VoIP terminal according to claim 7, further comprising an updating portion adapted to update the terminal information of the certain terminal of the multicast group in response to the terminal information update request for VoIP communication from the certain terminal in the multicast group, and to transmit the changed VoIP terminal information to the at least one terminal in the multicast group in response to the VoIP terminal information being changed.

13. A Voice-over Internet Protocol (VoIP) system comprising:
a VoIP terminal and a server;
wherein the VoIP terminal is adapted to generate a location registration message for VoIP communication, to transmit the location registration message to the server, to join a multicast group identified by a location registration complete message received from the server, and to transmit a request message for receiving terminal information to at least one terminal in the multicast group in response to the request for receiving terminal information from a receiving terminal with which the VoIP terminal is attempting to communicate, and to communicate with the receiving terminal based on the receiving terminal information received from a certain terminal in the multicast group; and
wherein the server is adapted to register the location of the VoIP terminal based on VoIP terminal information included in the location registration message upon receiving the location registration message, to identify the multicast group of the VoIP terminal based on the VoIP terminal information, and to transmit multicast group information of the VoIP terminal on the location registration complete message to the VoIP terminal.

14. An information management method of a Voice over Internet Protocol (VoIP) terminal, the method comprising:
transmitting a request message for receiving terminal information to at least one terminal in a multicast group at a request for receiving terminal information of a receiving terminal with which the VoIP terminal is attempting to communicate; and
communicating with the receiving terminal based on the receiving terminal information received from a certain terminal in the multicast group.

15. The information management method according to claim 14, wherein the receiving terminal information includes at least one piece of information selected from a group consisting of a user name, a telephone number and an IP address of the receiving terminal.

16. The information management method according to claim 14, wherein the request message for receiving terminal information includes at least one piece of information selected from a group consisting of a user name of the VoIP terminal, a telephone number of the VoIP terminal, an IP address of the VoIP terminal, a user name of the receiving terminal and a port number identifying an application necessary for communication between the VoIP terminal and the receiving terminal.

17. The information management method according to claim 14, wherein the receiving terminal information received from the certain terminal in the multicast group includes at least one piece of information selected from a group consisting of a user name of the receiving terminal, a telephone number of the receiving terminal, an IP address of the receiving terminal and a port number identifying an application necessary for communication between the VoIP terminal and the receiving terminal.

18. The information management method according to claim 14, further comprising:
updating the terminal information of the certain terminal of the multicast group in response to a terminal information update request for VoIP communication from the certain terminal in the multicast group; and
transmitting the changed VoIP terminal information to the at least one terminal in the multicast group upon information of the VoIP terminal being changed.

19. An information management method of a Voice over Internet Protocol (VoIP) system including at least one terminal and a server, the method comprising:
transmitting terminal information on a location registration message for VoIP communication to the server from a terminal;
location-registering the terminal based upon the terminal information in the location registration message upon receiving the location registration message, identifying a multicast group of the terminal based upon the terminal information, and transmitting multicast group information of the terminal on a location-registration complete message to the terminal from the server; and
joining the multicast group of the terminal included in the location-registration message received from the server at the terminal, and transmitting a request message for the receiving terminal information to at least one terminal of the multicast group from the terminal in response to a request for receiving terminal information from a receiving terminal with which the terminal is attempting to communicate.

20. The information management method according to claim 19, further comprising:
updating the terminal information of the terminal belonging to the multicast group at the terminal in response to a request from a terminal belonging to the multicast group to update terminal information of the terminal of the multicast group for VoIP communication;
transmitting the terminal information to the at least one terminal of the multicast group from the terminal upon the terminal information being changed; and
requesting a call to the receiving terminal based upon the receiving terminal information from the terminal in response to a call request to the receiving terminal.
